(19) United States
(12) Patent Application Publication
(10) Pub. No.: US 2012/0323810 A1
(43) Pub. Date: Dec. 20, 2012

(54) SOCIAL NETWORKING IDENTIFICATION METHOD

(76) Inventor: Nicola Nicolazzo, Waltham, MA (US)

(21) Appl. No.: 13/160,077

(22) Filed: Jun. 14, 2011

(51) Int. Cl. G06Q 99/00

(52) U.S. Cl. 705/319

(57) ABSTRACT

A method of locating and identifying users of a social networking service. The method involves signing up for the service, receiving and displaying merchandise tagged with a unique user identification code, allowing others to view the user identification code and/or viewing the user identification codes of others, and using the user identification codes to identify and contact users of the social networking service.

### BACKGROUND OF THE INVENTION

1. Field of the Invention

The present invention relates generally to social networking and dating services. More particularly, the present invention relates to a method of tagging to allow users of a social networking environment to find and connect with each other.

2. Description of Related Art

Social networking websites have become a major aspect of today's society. One form of a social networking website is the online dating website, where single persons are matched together based on site-specific criteria. Another form is the networking website that allows a user to keep in contact with friends and acquaintances. Some of these websites allow you to purchase mobile applications as an extension of the website. Presently, this creates two separate spheres for single persons to find a match: The material life and the digital life.

The two spheres, as they stand currently, are largely separate. Most people would not recognize that somebody they are matched with or converse with on an online dating website is actually somebody they may see everyday or that somebody they meet in everyday life is actually somebody that they would be matched with on an online dating website.

In addition, other social networking sites focus primarily on reuniting missed personal connections. The methods for doing so are quite arcane, as all that these users are able to do is cite a time and place where they saw, met, or spoke to this person.

Furthermore, the typical social networking site, such as Facebook® or Linkedln®, has other issues that have yet to be solved. For instance, locating a new acquaintance on a social networking site can be very troublesome if the new acquaintance or business contact has a common name or if only first names and minimal other information were exchanged. Even further, since most social networking sites have a very easy registration process where personal information does not need to be verified, fake accounts are prominent, whether they be accounts for real people but run by another or accounts for real users using fake names and contact information. These issues only complicate the procedure for locating a new acquaintance on a social networking site in order to continue the relationship/friendship/business partnership.

Therefore, what is needed is a social networking service that goes beyond what is currently available and will be able to successfully merge the two spheres. To allow for effective identification of the social networking service.

### SUMMARY OF THE INVENTION

The subject matter of this application may involve, in some cases, interrelated products, alternative solutions to a particular problem, and/or a plurality of different uses of a single system or article.

In one aspect, a method of locating a user of a social networking service is provided. This method comprises signing up for the social networking service, receiving a unique user identification code, displaying an item of merchandise marked with the user identification code, viewing a second item of merchandise marked with a second user identification code, recording the second user identification code, accessing the social networking service, identifying a user associated with the user identification code, and contacting the user.

In another aspect, a method of identifying potential matches on an online dating service is provided. This method comprises signing up for the online dating service, providing a quantity of personal information to the online dating service, receiving a unique user identification code, ordering an item of merchandise marked with the user identification code, receiving the item of merchandise ordered, displaying the item of merchandise, viewing a second item of merchandise marked with a second user identification code, recording the second user identification code, accessing the social networking service with the computer, identifying the user that may be a potential match using the recorded user identification code, and contacting the user that may be a potential match.

In yet another aspect, a method of facilitating connections through a social networking service is provided. This method comprises providing a user access to the social networking service through a networked computer, receiving a quantity of personal information from the user, providing a unique user identification code to the user, providing to the user an item of merchandise marked with the user's user identification code for the user to display, and providing a second user computer network access to the social networking service, wherein the second user may search, identify and contact the user based on the user's user identification code marked on the merchandise item displayed by the user.

### BRIEF DESCRIPTION OF THE DRAWINGS

FIG. 1 provides a flow chart of one embodiment of the present invention.

FIG. 2 provides a flow chart of another embodiment of the present invention.

FIG. 3 provides a flow chart of another embodiment of the present invention directed at an online dating service.

FIG. 4 provides a flow chart of another embodiment of the present invention directed at an online dating service.

FIG. 5 provides a flow chart of one server-side embodiment of the present invention.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention provides a method of identifying and contacting users of a social networking service. The method may include the steps of signing up for a social networking service, displaying a unique user identification code (hereinafter referred to as “user ID”), viewing a unique user ID displayed by another user, and finding that user on the social networking service website by searching for the user using the user ID viewed.

The social networking service contemplated herein may allow for the matching of singles in the digital life in such a way that it will act as an extension of the material life rather than a replacement. In addition, the service may allow for an advanced way to reunite those seeking to realize a personal connection with someone they failed to realize one with. Finally, the service may incorporate a method to uniquely match a person's profile to their social networking service account to conquer the confusion of common names, lack of information, and fake accounts.

The social networking service contemplated herein may serve a number of purposes without straying from the scope of the present invention. For example, the social networking service may allow users to engage in non-romantic relationships, keep in touch with acquaintances, friends and family, professional business relationships, and romantic relationships, may allow communication between users on a message board or internet forum, and may allow users to follow up on missed-connections that otherwise may never be realized.

The step of signing up for a social networking service may include the steps of visiting a website using a computer, providing personal information to generate a user account, receiving a user ID, computer generated email address, and customizable personal user page, and selecting from varying subscription services, including a free service and a paid service.

The step of visiting a website using a computer may be carried out using any internet accessible device, including desktop or laptop computers, internet enabled phones, internet enabled tablets, and the like. Multiple interfaces may be employed to visit the website. For example, there may be an internet browser-accessible webpage, or there may be a computer application designed specifically to access the social networking service and present it within the application.

In one embodiment, the step of providing personal information to start an account may be performed by a user filling in an online form. This form may require users to fill in fields on the form. These fields may include: first and last name, email address, a desired password, phone number, gender, birth date, address, geographic region, education information, employment information, interests, relationship information and interests, family information, religious views, ethnicity, physical features including hair color, eye color, measurements, and the like, type of relationship being sought, living situation, answers to quiz questions, and a personal description about interesting personality traits, among other things. In addition, users may upload one or a plurality of photographs for other users to view, or for users to store the photo or photos on a server of the social networking service.

In another embodiment the step of providing personal information to start an account may be performed automatically. In this embodiment, the social networking service may be configured to access, via computer, contact lists or other sources of information that may include the type of information listed above.

In a further embodiment, the step of providing personal information to start an account may be automated by importing data containing the personal information required from other social networking services including but not limited to Facebook®, LinkedIn®, MySpace®, Match.com®, EHarmony.com®, a user's email or contact list, v-card, and the like.

After a specified level of information is provided, a unique user ID may be provided to the user. In one embodiment, the user ID may be generated by computer. In another embodiment, the user ID may be chosen by the user. This unique user ID may allow the user to be searched and identified by other users and potential users. Also, a computer generated email address may be provided to a user. In one embodiment, this email address may be the user's user ID followed by “@iseenya.com.” In another embodiment, the email address may be the user's user ID directed to another domain name.

In one embodiment, a computer generated personal page may be provided to a user. The personal page may utilize a computer to automatically import the information provided when signing up with the social networking service. In another embodiment, the information and formatting of the personal page may be customizable.

The user ID may be of any format that allows unique identification of a user of the social networking service. For example, the user ID may be in the form of an identification number, a bar code, icon, scannable image, user-name, radio frequency identification (RFID) tag, or any combination thereof.

In an embodiment where the user ID is generated by computer, the personal information a user provides when signing up may influence the user ID generated. For example, users who indicate interests such as dating may be given a certain type of user ID that may be different from users who indicate interests in maintaining connections with acquaintances. In another example, a user ID may be generated based on name and location information, or personality trait information.

In one embodiment, a user may sign up for different types or levels of service. One embodiment may allow a user to sign up for a free service, or a paid service. Another embodiment may allow a user to sign up for a free social networking service, a paid social networking service, a free dating service and a paid dating service.

In another embodiment, the service may have multiple incremental service levels. In one embodiment, the service may provide limited access to non-paying users, slightly enhanced access with a first payment level, and full access with a second payment level. This embodiment may allow users to access more services and features as they pay a higher fee. The additional services and features may include, for example, enhanced communication abilities or options for dating/non-dating, among other things.

The step of displaying a unique user ID may involve the steps of ordering merchandise, receiving the merchandise, and displaying the merchandise.

The merchandise contemplated herein may be any item that can be tagged with the social networking service's logo, and a particular user's user ID. The merchandise is tagged with the social networking service's logo and a particular user's user ID to allow people, both users and potential users, to see a person's user ID, access the social networking service, and look that person up based on their user ID. Examples of merchandise that may display a logo and user ID may include stickers or magnets, clothing, neck ties, sunglasses, bags, hats, jackets, key chains, posters and other apparel, among other things.

Merchandise tagged with the logo and user ID may be ordered in a variety of manners. For example, ordering may be performed by a user over the phone, by mail, or in a computer-based online setting. In one embodiment, a user may order by paying for the merchandise and providing shipping information. In another embodiment, a user may order by providing a shipping address, and the merchandise may be provided free as a benefit of signing up for the social networking service. In yet another embodiment, a user who has signed up for a paid service may order by providing shipping information, and the merchandise may be provided free as a benefit of signing up for the paid social networking service.

In still another embodiment, a license may be provided to a user to permit the user to create their own merchandise marked with their user ID. This merchandise may be marked using a printer. The printer may be any device capable of marking the merchandise. For example, a computer printer may be used, or a stencil and marker combination, or the user ID could be painted on to merchandise. This license may be purchased in one embodiment. In another embodiment, the license may be provided as a benefit of signing up with the social networking service.

Once the merchandise tagged with a user's user ID has been received, a user may publicly display the merchandise. Typically, the goal of displaying the merchandise is to make a user's social networking personal page identifiable and easily accessible to other users, non-users, or both.

In one embodiment, merchandise such as a sticker may be displayed on a window of a user's house, office, or vehicle. Therefore, a person who would like to contact the user could note the user ID, and subsequently find the user on the social networking service.

In another embodiment, merchandise such as a t-shirt could be worn out to a bar, party, club, restaurant, or other social event. In this embodiment, a person who sees the user could identify and record the user's user ID. The person may find and access the user's social networking service personal page using the user ID, and contact the user if they wished.

In yet another embodiment, merchandise such as a bag or jacket may be worn to a workplace or office. In this embodiment, those in a user's office may view the user's user ID. In turn, office mates, clients, or the like wishing to contact the user may find and access the user's social networking service personal page using the user ID, and contact the user if they wished.

In still another embodiment, a poster displaying the social networking logo and a user's user ID may be displayed prominently in a window, outside of a user's house, office, or in a store-front. In this embodiment, a person who sees the poster displayed in the window may record the user ID displayed, and may find and access the user's social networking service personal page using the user ID, and contact the user if they wished.

In yet another embodiment, a user ID may be disposed on a keychain or other small item. In this embodiment, if a person meets a user that they find interesting in a social setting, the user may display their user ID to the person. The person may then record the user ID, and use the user ID to access the user's personal page on the social networking service.

The step of contacting a user may include the steps of viewing the user ID of a user, recording user ID, accessing the social networking service, searching using the user ID, accessing the user's personal page, and contacting the user.

The step of viewing the user ID of a user may be performed in any manner depending on how a user displays the user ID. In one embodiment, a potential user may view a sticker imprinted with a user ID in a user's window. In another embodiment, a user ID may be displayed on a user's vehicle. In still another embodiment, a potential user may view a user ID on a user's apparel.

The step of recording a user ID may be performed in any manner such that the user ID may be accessed and re-accessed for a time period long enough to allow access to the social networking site. In one embodiment the recording may be performed manually by writing the user ID down. In another embodiment, the user ID may be inputted into a cellular telephone, smart phone, computer, or other device that may store information. In yet another embodiment, the user ID may be recorded by photographing the user ID using a camera. In a further embodiment, the camera may be mounted to a cellular telephone. In still another embodiment, the user ID may be memorized for a short period of time until an internet enabled device may be accessed and utilized to search for a user based on their user ID. In a further embodiment, a user ID may be scanned using a receiver of a mobile computing device.

The step of accessing the social networking service may be performed on any internet enabled device such as a computer, cell phone, internet enabled cellular phone, internet enabled tablet computer, and the like. In one embodiment, the access may be performed through an internet browsing application. In another embodiment, the access may be performed through a computer application designed to interface with the social networking service.

In a further embodiment, a person who wishes to search for a user may be required to sign up for the social networking service before they can access the service, and search for a user's user ID.

The step of searching for a user based on a user ID may be performed through the social networking service. In one embodiment, a user ID may be inputted manually into a search field. In another embodiment, a user ID may be searched based on an alpha-numeric listing displayed on a website of the social networking service. In a further embodiment, name searches, interest searches, and other searches may be available in addition to a search based on a user ID. In still another embodiment, a computer may be configured to extract a user ID from a photograph using character recognition techniques. In this embodiment the extracted user ID may be automatically imported into the user ID search field, and the user may be located on the social networking service.

In one embodiment, the step of searching may involve a commonality search. In this embodiment, a user may be allowed to search only for those members who have listed information in common with the user. For example, commonalities searched may include common location, common employment areas, common relationship interests, or common ages, among other things.

After a user has been located based on a user ID, their personal page may be accessed, allowing an interested party to view their information and interests displayed on the page, and to potentially contact the user.

The step of contacting a user may be performed in any manner based on the contact information found on a user's personal page of the social networking service. For example, contact information that may be provided may include electronic mail address, physical mail address, phone number, external webpage URL, Skype® user name, or any other information that may allow interested parties to contact the user.

In one embodiment, a messaging feature may be built into the social networking service, allowing one user to contact another user through the social networking service.

In another embodiment, a user may display an electronic mail address that may allow a second user to contact them. In one embodiment, the electronic mail address may be provided by the social networking service. In another embodiment, the electronic mail address may be provided by an external service on a computer.

In another embodiment, a live chat feature may be incorporated into the social networking service. The live chat feature may allow users to contact each other while they are logged into the social networking service on a computer.

The present invention may further be enhanced by the use of a mobile computing device such as an internet enabled phone, smart phone, cellular telephone, personal digital assistant (PDA) or tablet device. For example in one embodiment an application for a mobile computing device may be employed to access the social networking service.

In another embodiment, an application for a mobile computing device may be configured to utilize a signal broadcasting element of the device to broadcast a user's user ID within a certain range. In this embodiment, a second mobile computing device may configured to utilize a signal receiving element of the device to receive and record a user ID that may be broadcast by a user. This reception may be automated, or may be performed manually by activating the signal broadcasting or receiving elements. In this embodiment, users may broadcast, receive and record each other's user ID using mobile computing devices. The mobile computing device may be further configured to automatically search the user ID's it has received and to present the corresponding user information in an organized fashion. The broadcasting, receiving and recording may be automated, thereby allowing users of the social networking service to automate the searching aspects of the social networking service.

In another embodiment, the mobile application may include a location feature. In this embodiment, the broadcasting element of the mobile computing device may broadcast a user's location to others who may use the signal receiving element of other mobile computing devices. The mobile computing device may be configured to display the locations of other users and allow a user to see who is in their current area at a given time by plotting user locations on a map. Users may then be able to visit locations of other users to view and record the users user IDs.

Other possible features that may be available to the mobile computing device may include a notification feature that notifies the user via the mobile computing device when another user has contacted them, a scanning feature that allows rapid recording of a user's user ID, or a check-in feature that allows the user to mark what locations they frequent, showing other users where they like to go consistently, among other things.

In one embodiment, the application for a mobile computing device may be provided free of charge. In another embodiment, the application may be provided for a one time fee. In still another embodiment, the application may be provided for a periodic fee.

In still another embodiment, merchandise may be provided that includes a radio frequency identification (RFID) chip which may allow a user's user ID to be recorded by a reader. In this embodiment, a signal receiving element of a mobile computing device may be configured to act as a reader to automatically receive and record a user ID from this RFID chip when the device is within a specific proximity to the RFID chip. In this embodiment a user may be able to periodically review user ID's gathered by a mobile computing device, and use the user ID's to search users of the social networking service. In another embodiment, the mobile computing device may be touched or brought in close proximity to the RFID chip and the user ID of the RFID chip may be automatically recorded by a receiver of the mobile computing device.

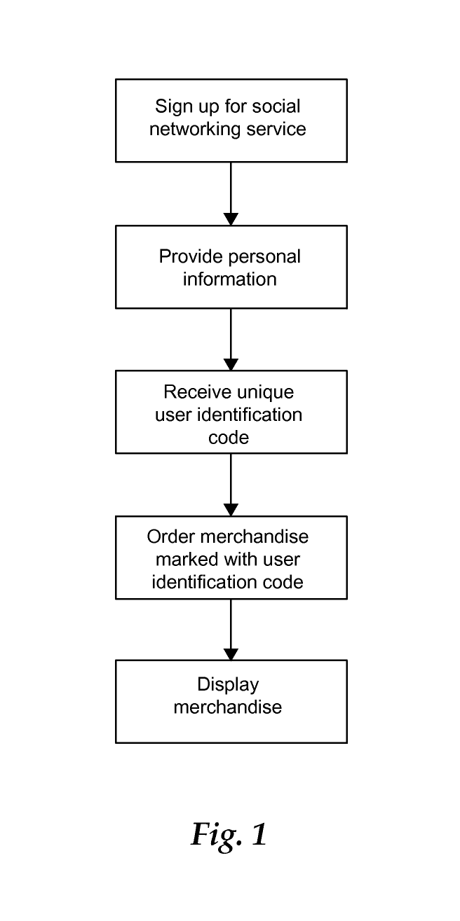

Turning now to FIG. 1 a flow chart of one embodiment of the present invention is shown. The flow chart shows the ordered steps of: signing up for the social networking service, providing personal information to the social networking service, receiving a unique user identification code that is tied to a user on the social networking service, ordering merchandise marked with the user identification code, and displaying the merchandise marked with the user identification code with the goal of allowing others to identify a user based on the displayed user identification code.

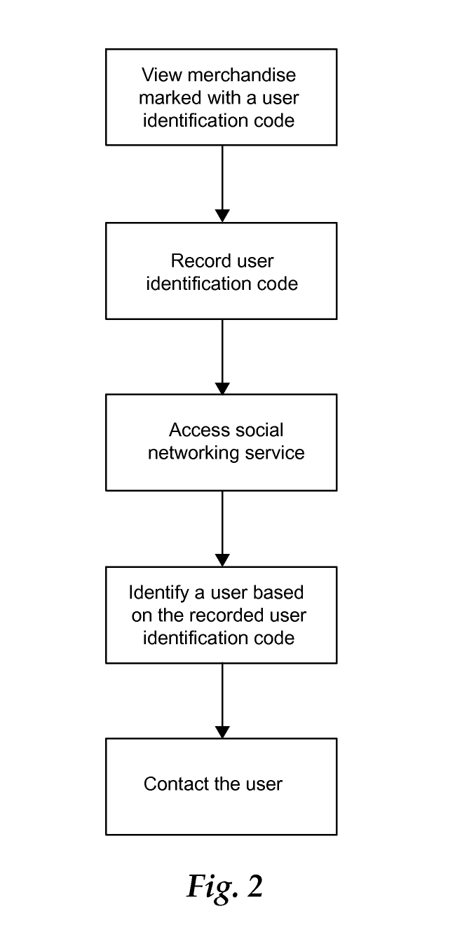

FIG. 2 shows a flow chart of another embodiment of the present invention. The flow chart of FIG. 2 may follow on the steps of FIG. 1, and shows the ordered steps of: viewing displayed merchandise marked with a user identification code, recording the user identification code, accessing the social networking service, identifying a user based on the recorded user identification code, and contacting the user tied to the particular user identification code.

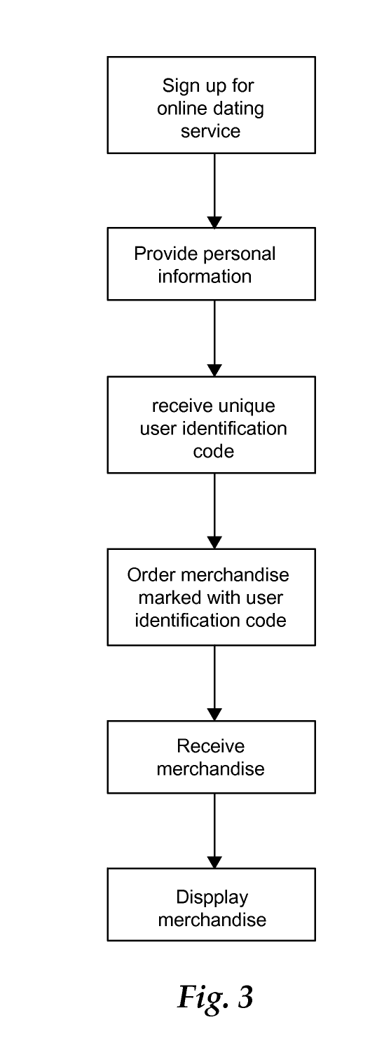

FIG. 3 provides a flow chart of another embodiment of the present invention directed at an online dating service. FIG. 3 shows the ordered steps of: signing up for an online dating service, providing personal information to the online dating service, receiving a unique user identification code that is tied to a user on the online dating service, ordering merchandise marked with the user identification code, receiving the merchandise, and displaying the merchandise marked with the user identification code with the goal of allowing others to identify a user based on the displayed user identification code.

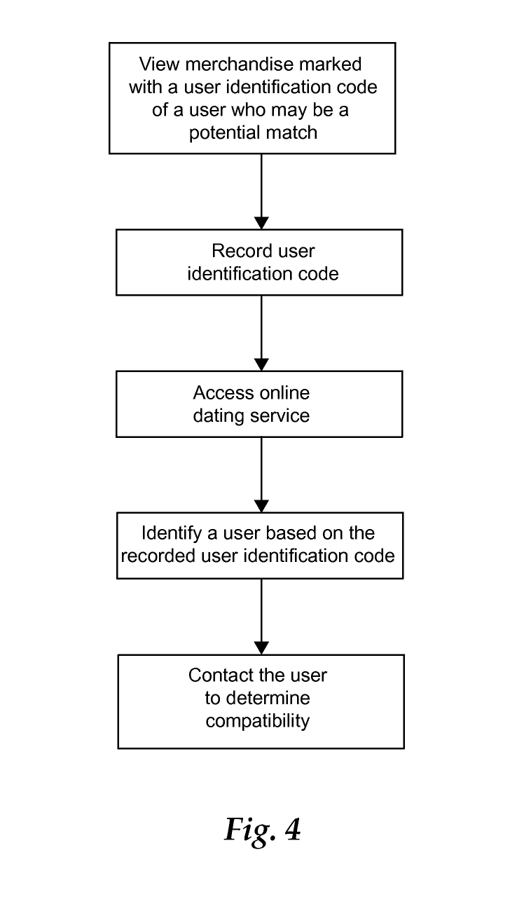

FIG. 4 provides a flow chart of another embodiment of the present invention directed at an online dating service. The flow chart of FIG. 4 may follow on the steps of FIG. 3, and shows the ordered steps of: viewing displayed merchandise marked with a user identification code of a user who may be a potential match, recording the user identification code, accessing the online dating service, identifying a user based on the recorded user identification code, and contacting the user tied to the particular user identification code to determine compatibility.

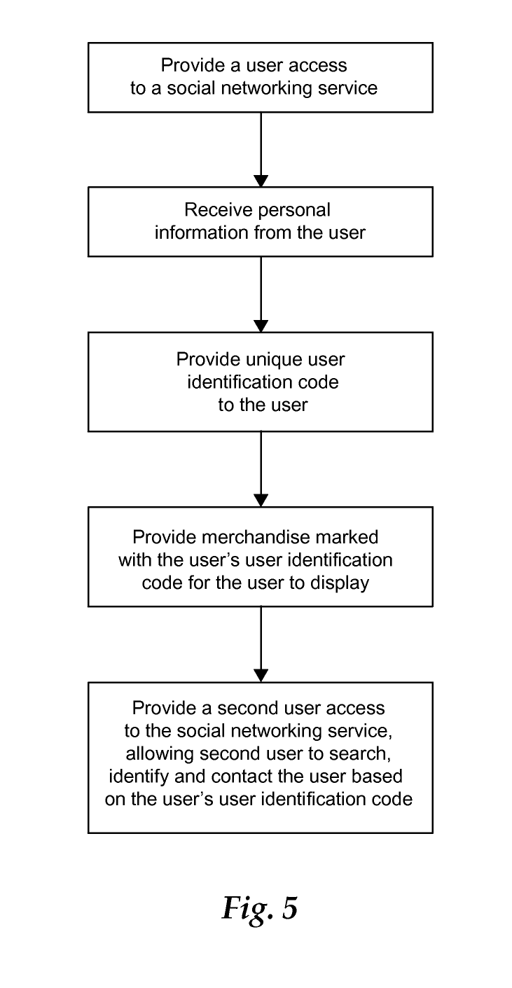

FIG. 5 provides a flow chart of one server-side embodiment of the present invention. FIG. 5 shows the steps of providing a user access to a social networking service, receiving personal information from the user during the sign up process to develop and populate a user profile, providing a unique user identification code to the user, providing merchandise marked with the user's user identification code for the user to display, and providing a second user access to the social networking service to allow the second user to search, identify and contact the user based on the user's user identification code.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A method of locating a user of a social networking service comprising the steps of:
signing up for the social networking service using a computer having network access by providing a quantity of personal information;
receiving a unique user identification code provided by the social networking service;
displaying an item of merchandise marked with the user identification code;
viewing a second item of merchandise marked with a second user identification code displayed by a second user;
recording the second user identification code;
accessing the social networking service with the computer having network access;
identifying a user based on the recorded second user identification code;
contacting the user associated with the second user identification code.

2. The method of locating a user of a social networking service of claim 1 further comprising the step of ordering an item of merchandise marked with the user identification code.

3. The method of locating a user of a social networking service of claim 2 wherein the item of merchandise is a T-shirt.

4. The method of locating a user of a social networking service of claim 2 wherein the item of merchandise is a magnet.

5. The method of locating a user of a social networking service of claim 2 further comprising the step of customizing a computer generated personal webpage of the social networking service using the computer having network access.

6. The method of locating a user of a social networking service of claim 1 further comprising the steps of
receiving a license from the social networking service; and
marking the item of merchandise with a user identification code using a printer.

7. The method of locating a user of a social networking service of claim 1 wherein the step of displaying an item of merchandise marked with the user identification code comprises publicly displaying the item of merchandise.

8. The method of locating a user of a social networking service of claim 1 wherein the step of contacting the user comprises identifying contact information provided by the user, and utilizing the contact information to contact the user.

9. The method of locating a user of a social networking service of claim 1 wherein the step of recording the second user identification code comprises photographing a displayed user identification code with a camera.

10. The method of locating a user of a social networking service of claim 1 wherein the step of accessing the social networking service with the computer, and the step of recording the second user ID code is performed using an internet enabled mobile device.

11. The method of locating a user of a social networking service of claim 10 further comprising the steps of:
broadcasting a signal containing the user identification code using the internet enabled mobile device; and
receiving a signal containing the second user identification code using an internet enabled mobile device.

12. The method of locating a user of a social networking service of claim 11 wherein the steps of broadcasting a signal containing the user identification code and receiving a signal containing the second user identification code are performed automatically without activation by a user by the internet enabled device.

13. The method of locating a user of a social networking service of claim 2 wherein the item of merchandise further comprises a radio frequency identification chip that displays the user identification code to a radio frequency identification receiver.

14. A merchandise-based method of identifying potential matches on an online dating service comprising the steps of:
signing up for the online dating service using a computer;
providing a quantity of personal information to the online dating service;
receiving a unique user identification code;
ordering an item of merchandise marked with the user identification code;
receiving the item of merchandise ordered;
displaying the item of merchandise;
viewing a second item of merchandise marked with a second user identification code displayed by a user of the online dating service that may be a potential match;
recording the second user identification code;
accessing the online dating service with the computer;
identifying the user that may be a potential match using the recorded user identification code; and
contacting the user that may be a potential match to determine compatibility.

15. The merchandise-based method of identifying potential matches on an online dating service of claim 14 further comprising the steps of:
reviewing a quantity of personal information provided to the online dating service to determine compatibility with the user;
identifying contact information provided by the user; and
utilizing the contact information to contact the user.

16. A merchandise-based method of facilitating personal connections through a social networking service comprising the steps of:
providing a user access to the social networking service through a networked computer;
receiving a quantity of personal information from the user;
providing a unique user identification code to the user;
providing to the user an item of merchandise marked with the user's user identification code for the user to display; and
providing a second user computer network access to the social networking service, wherein the second user may search, identify and contact the user based on the user's user identification code marked on the merchandise item displayed by the user.

17. The merchandise-based method of facilitating personal connections through a social networking service of claim 16 further comprising the steps of: providing computer network access to a merchandise ordering service, the merchandise ordering service allowing the user to order the item of merchandise marked with the user's user identification code using a computer.

18. The merchandise-based method of facilitating personal connections through a social networking service of claim 16 wherein the item of merchandise marked with the user identification code provided comprises at least one of a visual marking and a radio frequency identification chip marking.

19. The merchandise-based method of facilitating personal connections through a social networking service of claim 18 further comprising the step of providing a mobile device application that allows a mobile device to act as a receiver to access the user identification code from the radio frequency identification chip.

20. The merchandise-based method of facilitating personal connections through a social networking service of claim 16 wherein the step of providing a unique user identification code is performed by a computer and wherein the user identification code generated is based on the quantity of information provided.
